(19) United States
(12) Patent Application Publication
(10) Pub. No.: US 2011/0177838 A1
(43) Pub. Date: Jul. 21, 2011

(54) METHOD AND SYSTEM FOR SPACE-TIME POWER CONTROL FOR MIMO TRANSMISSIONS

(75) Inventor: Kim Olszewski, South Jordan, UT (US)

(73) Assignee: ZTE (USA) INC., San Diego, CA (US)

(21) Appl. No.: 13/003,267

(22) PCT Filed: Jul. 7, 2009
(86) PCT No.: PCT/US09/49842

§ 371 Date: Mar. 23, 2011

Related U.S. Application Data
(60) Provisional application No. 61/078,738, filed on Jul. 7, 2008.

(51) Int. Cl. H04W 52/04

(52) U.S. Cl. 455/522

(57) ABSTRACT

A system for controlling transmit power at a station in a multiple in, multiple out (MIMO) system is disclosed. The system includes a signal to interference-plus-noise ratio (SINR) generator configured to predict a post-processing SINR, based on at least one previous and current SINR estimate, for each spatial stream. A power control bit (PCB) generator is configured to generate at least one PCB based on the predicted SINR, which is transmitted to the station at which transmit power is controlled, by a transceiver module, where the stations is a base station or a mobile station. A power control step (PCS) generator is configured to determine a PCS size based on the PCB.

### CROSS-REFERENCE TO RELATED APPLICATIONS

This application claims priority to U.S. Provisional Patent Application No. 61/078,738 filed on Jul. 7, 2008, entitled “Space-Time Power Control for MIMO Transmissions”, the contents of which are incorporated by reference herein in their entirety.

### FIELD OF THE INVENTION

The present invention relates generally to wireless communication systems, and more particularly to transmission power control of multiple-input, multiple-output (MIMO) communication systems.

### BACKGROUND

Traditionally, multiple-input, multiple-output (MIMO) communication systems employ N_{T}>1 transmit antennas and N_{R}>=1 receive antennas. An N_{R}-by-N_{T} MIMO channel may be decomposed into N_{S}<=min(N_{T}, N_{R}) independent spatial subchannels when the MIMO channel matrix is a full-rank matrix. MIMO system channel conditions typically vary with time so the N_{S} spatial subchannels experience different subchannel conditions that results in different received signal post-processing signal to interference-plus-noise ratios (SINRs). Consequently, the data rates that may be supported by the spatial subchannels may be different for the N_{S} spatial subchannels. A key challenge in a MIMO system implementation is the specification of antenna transmit powers to use for spatial subchannel data transmissions. Transmit power control methods may reduce inter- and intra-cell interference, compensate for signal fades and path loss, and facilitate network functions such as BS selection. In addition, for OFDM-based transmissions, subcarrier power concentration is allowed. A base station can specify the amount of power to be allocated to subcarriers and thereby provide for improvements in coverage, received subcarrier SINR values, and improved subcarrier frequency reuse.

Power control methods can be categorized as open- or closed-loop. Open-loop methods compensate for slow signal power variations associated with signal propagation path length and signal shadowing. However, open loop power control is more subject to calibration error, channel quality measurement errors, and fast time-varying channels. To correct for errors associated with open loop power control and to track fast time-varying channels and interference a mechanism of closed loop is required for the power control. In closed-loop power control a receiver adaptively commands a transmitter to update its transmit power level based on received channel quality measurements (e.g. SINR) of the transmitter's signal. The control loop has to compensate for small-scale fading, hence, the feedback rate should be on the order of Doppler frequency for optimal results. Closed-loop power control performance may be affected by power control parameters such as power control step size, power-update rate, channel quality measurement accuracy, power update feedback delay, and the reliability of power increment or decrement commands in the form of power control bits (PCBs).

Feedback delay is a critical closed-loop power control parameter. To minimize feedback delay predictive closed-loop power control may be used. In predictive closed-loop power control, future received channel quality SINR values are predicted using previous and present SINR estimates. P CBs are subsequently generated using predicted SINR values rather than SINR estimates. Thus PCBs based on predicted SINR values better track changes in channel and interference-plus-noise power which occur during closed-loop processing.

Power control step (PCS) sizes that better match variations in received SINR will improve closed-loop power control tracking performance and increase network capacity. A larger power control step size is better suited to track rapid deviations in received SINR; slow deviations in received SINR are better tracked using a smaller step size.

However, power control-loop error increases if PCSs do not inversely match changes in received SINR. A type of error called slope-overload error results if the PCS size is too small to inversely track segments of received SINR that have fast or abruptly changing slopes. For example, slope-overload will arise if the PCS size is fixed at 1 dB, the received interference-plus-noise power is constant, and received signal power decreases at 2 dB per subframe. Conversely, if the PCS size is too large in segments of received SINR that have small slopes a type of error called granular error will arise. A solution to the slope-overload and granular errors is the incorporation of PCS size adaptation into closed-loop power control. PCS size adaptation must optimally set power control step sizes in accordance with changes in received SINR.

Accordingly, it would be beneficial to have a closed-loop power control technique to control the transmit power of the spatial streams in a MIMO system utilizing post-processing SINR values and PCBs.

### SUMMARY

The presently disclosed embodiments are directed to solving one or more of the problems presented in the prior art, described above, as well as providing additional features that will become readily apparent by reference to the following detailed description when taken in conjunction with the accompanying drawings.

In the following description, embodiments of the disclosure are disclosed that support numerous channel bandwidths defined in the 802.16 Requirements Document and the numerous radio environments and associated channel conditions defined in the 802.16 Evaluation Methodology Document, to illustrate various principles of the disclosure.

Certain embodiments implement the usage of SINR prediction and adaptive PCS size prediction within a closed loop power control implementation. As described below, SINR values may be adaptively predicted using previous and present SINR estimates. The predicted SINR values are subsequently used to generate PCBs. Adaptive SINR prediction may help lessen the incorrect setting of PCBs. Using the proposed techniques, PCS sizes for a transmitter may be adaptively predicted using previous and present detected PCBs. Slope overload and granular error arise due to non-optimal PCS sizes; however, adaptive PCS sizes help lessen slope overload and granular errors. Another advantage in using received PCBs for adaptively predicting PCSs is that 1-bit power command signals may be used for multiple step-size power control. In contrast, if multiple size PCSs (2 or more bits in length) were transmitted, then extra bandwidth would be required.

One embodiment of the present disclosure is directed to a method for controlling transmit power at a station in a multiple in, multiple out (MIMO) system. The method includes predicting a post-processing signal to interference-plus-noise ratio (SINR), based on at least one previous and current SINR estimate, for each spatial stream; generating at least one power control bit (PCB) based on the predicted SINR; and transmitting the PCB to the station at which transmit power is controlled. Thereafter, the station can determine a power control step (PCS) size based on the PCB.

Another embodiment is directed to system for controlling transmit power at a station in a MIMO system. The system includes an SINR generator configured to predict a post-processing SINR, based on at least one previous and current SINR estimate, for each spatial stream. A PCB generator is configured to generate at least one PCB based on the predicted SINR. Thereafter, a transceiver module transmits the PCB to the station at which transmit power is controlled. The stations can be a base station or a mobile station. APCS generator is configured to determine a PCS size based on the PCB at the station at which transmit power is controlled.

Yet another embodiment is directed to a computer-readable medium storing instructions thereon for performing a method of controlling transmit power at a station in a MIMO system. The method includes predicting a post-processing SINR, based on at least one previous and current SINR estimate, for each spatial stream; and generating at least one PCB based on the predicted SINR. The method can further include transmitting the PCB to the station (e.g., a base station or a mobile station) at which transmit power is controlled. Thereafter, the station can determine a power control step (PCS) size based on the PCB.

Yet another embodiment is directed to a system that includes means for predicting a post-processing signal to interference-plus-noise ratio (SINR), based on at least one previous and current SINR estimate, for each spatial stream of a multiple in, multiple out (MIMO) system. The system further includes means for generating at least one power control bit (PCB) based on the predicted SINR; and means for transmitting the at least one PCB to a station at which transmit power is controlled. The system may further include means for determining a power control step (PCS) size based on the PCB.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following Figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is an illustration of an exemplary OFDM/OFDMA mobile radio channel operating environment, according to an embodiment.

FIG. 2 is an illustration of an exemplary OFDM/OFDMA exemplary communication system according to an embodiment.

FIG. 3 is a detailed illustration of an exemplary base station and a base station processor module, according to an embodiment.

FIG. 4 is a detailed illustration of an exemplary mobile station and a mobile station processor module, according to an embodiment.

FIG. 5 is a graphical illustration of slope overload and granular errors, according to an embodiment.

FIG. 6 is an illustration of an exemplary power control step size generator, according to an embodiment.

FIGS. 7(a)-7(f) illustrate exemplary output signals from a power control step size generator, according to an embodiment.

FIGS. 8(a)-8(f) illustrate exemplary output signals from a power control step size generator, according to an embodiment.

FIG. 9 is a flowchart illustrating a method for controlling transmit power at a station in a multiple in, multiple out (MIMO) system, according to an embodiment.

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

The word “exemplary” is used herein to mean “serving as an example or illustration.” Any aspect or design described herein as “exemplary” is not necessarily to be construed as preferred or advantageous over other aspects or designs.

Reference will now be made in detail to aspects of the subject technology, examples of which are illustrated in the accompanying drawings, wherein like reference numerals refer to like elements throughout.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Embodiments disclosed herein describe a wireless cellular communication system where the transmission direction from a base station to mobile station is called downlink, while the opposite direction is called uplink. On both downlink and uplink, the radio signal transmissions over the time are divided into periodic frames (or subframes, slots, etc). Each radio frame contains multiple time symbols that include data symbols (DS) and reference symbols (RS). Data symbols carry the data information, while the reference symbols are known at both transmitter and receiver, and are used for channel estimation purposes. Note that the functions described in the present disclosure may be performed by either a base station or a mobile station. A mobile station may be any user device such as a mobile phone, and a mobile station may also be referred to as user equipment (UE).

Aspects of the present disclosure are directed toward systems and methods for OFDM/OFDMA frame structure technology for communication systems. Embodiments of the invention are described herein in the context of one practical application, namely, communication between a base station and a plurality of mobile devices. In this context, the exemplary system is applicable to provide data communications between a base station and a plurality of mobile devices. Embodiments of the disclosure, however, are not limited to such base station and mobile device communication applications, and the methods described herein may also be utilized in other applications such as mobile-to-mobile communications, or wireless local loop communications. As would be apparent to one of ordinary skill in the art after reading this description, these are merely examples and the invention is not limited to operating in accordance with these examples. Assignment of resources within a frame to the data being carried can be applied to any digital communications system with data transmissions organized within a frame structure and where the full set of such resources within a frame can be flexibly divided according to portions of different sizes to the data being carried. Thus, the present disclosure is not limited to any particular type of communication system; however, embodiments of the present invention are described herein with respect to exemplary OFDM/OFDMA systems.

As explained in additional detail below, the Orthogonal Frequency Division Multiplexing (OFDM)/OFDMA frame structure comprises a variable length sub-frame structure with an efficiently sized cyclic prefix operable to effectively utilize OFDM/OFDMA bandwidth. The frame structure provides compatibility with multiple wireless communication systems.

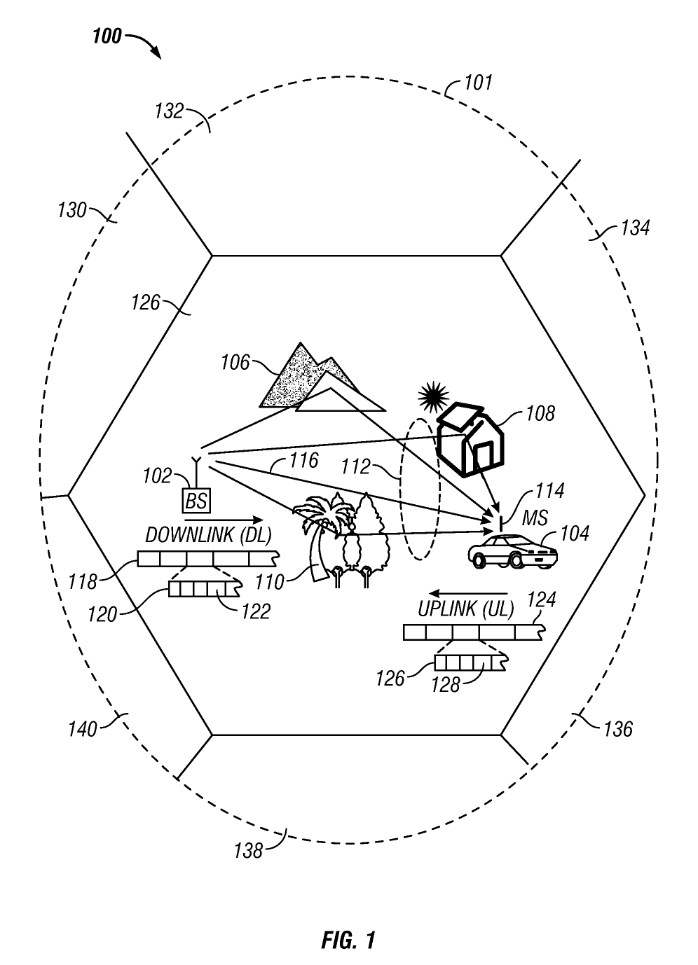

FIG. 1 illustrates a mobile radio channel operating environment 100, according to one embodiment of the present invention. The mobile radio channel operating environment 100 may include a base station (BS) 102, a mobile station (MS) 104, various obstacles 106/108/110, and a cluster of notional hexagonal cells 126/130/132/134/136/138/140 overlaying a geographical area 101. Each cell 126/130/132/134/136/138/140 may include a base station operating at its allocated bandwidth to provide adequate radio coverage to its intended users. For example, the base station 102 may operate at an allocated channel transmission bandwidth to provide adequate coverage to the mobile station 104. The exemplary mobile station 104 in FIG. 1 is an automobile; however mobile station 104 may be any user device such as a mobile phone. Alternately, mobile station 104 may be a personal digital assistant (PDA) such as a Blackberry device, MP3 player or other similar portable device. According to some embodiments, mobile station 104 may be a personal wireless computer such as a wireless notebook computer, a wireless palmtop computer, or other mobile computer devices.

The base station 102 and the mobile station 104 may communicate via a downlink radio frame 118, and an uplink radio frame 124 respectively. Each radio frame 118/124 may be further divided into sub-frames 120/126 which may include data symbols 122/124. In this mobile radio channel operating environment 100, a signal transmitted from a base station 102 may suffer from the operating conditions mentioned above. For example, multipath signal components 112 may occur as a consequence of reflections, scattering, and diffraction of the transmitted signal by natural and/or man-made objects 106/108/110. At the receiver antenna 114, a multitude of signals may arrive from many different directions with different delays, attenuations, and phases. Generally, the time difference between the arrival moment of the first received multipath component 116 (typically the line of sight component), and the last received multipath component (possibly any of the multipath signal components 112) is called delay spread. The combination of signals with various delays, attenuations, and phases may create distortions such as ISI and ICI in the received signal. The distortion may complicate reception and conversion of the received signal into useful information. For example, delay spread may cause ISI in the useful information (data symbols) contained in the radio frame 124.

OFDM can mitigate delay spread and many other difficult operating conditions. OFDM divides an allocated radio communication channel into a number of orthogonal subchannels of equal bandwidth. Each subchannel is modulated by a unique group of subcarrier signals, whose frequencies are equally and minimally spaced for optimal bandwidth efficiency. The group of subcarrier signals are chosen to be orthogonal, meaning the inner product of any two of the subcarriers equals zero. In this manner, the entire bandwidth allocated to the system is divided into orthogonal subcarriers. OFDMA is a multi-user version of OFDM. For a communication device such as the base station 102, multiple access is accomplished by assigning subsets of orthogonal sub-carriers to individual subscriber devices. A subscriber device may be a mobile station 104 with which the base station 102 is communicating.

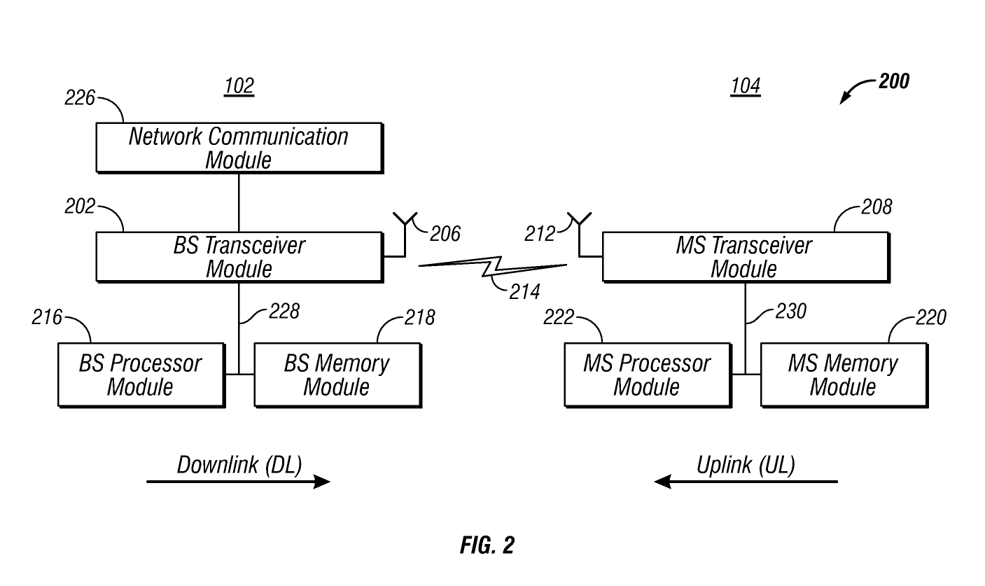

FIG. 2 shows an exemplary wireless communication system 200 for transmitting and receiving OFDM/OFDMA transmissions, in accordance with one embodiment of the present invention. The system 200 may include components and elements configured to support known or conventional operating features that need not be described in detail herein. In the exemplary embodiment, system 200 can be used to transmit and receive OFDM/OFDMA data symbols in a wireless communication environment such as the wireless communication environment 100 (FIG. 1). System 200 generally comprises a base station 102 with a base station transceiver module 202, a base station antenna 206, a base station processor module 216 and a base station memory module 218. As is described in greater detail herein, any number of base station antennas 206 may be included. System 200 generally comprises a mobile station 104 with a mobile station transceiver module 208, a mobile station antenna 212, a mobile station memory module 220, a mobile station processor module 222, and a network communication module 226. As is described in greater detail herein, any number of mobile station antennas 212 may be included. Of course both BS 102 and MS 104 may include additional or alternative modules without departing from the scope of the present invention.

Furthermore, these and other elements of system 200 may be interconnected together using a data communication bus (e.g., 228, 230), or any suitable interconnection arrangement. Such interconnection facilitates communication between the various elements of wireless system 200. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as causing a departure from the scope of the present invention.

In the exemplary OFDM/OFDMA system 200, the base station transceiver 202 and the mobile station transceiver 208 each comprise a transmitter module and a receiver module (not shown). Additionally, although not shown in this figure, those skilled in the art will recognize that a transmitter may transmit to more than one receiver, and that multiple transmitters may transmit to the same receiver. In a TDD system, transmit and receive timing gaps exist as guard bands to protect against transitions from transmit to receive and vice versa.

In the particular example of the OFDM/OFDMA system depicted in FIG. 2, an “uplink” transceiver 208 includes an OFDM/OFDMA transmitter that shares an antenna with an uplink receiver. A duplex switch may alternatively couple the uplink transmitter or receiver to the uplink antenna in time duplex fashion. Similarly, a “downlink” transceiver 202 includes an OFDM/OFDMA receiver which shares a downlink antenna with a downlink transmitter. A downlink duplex switch may alternatively couple the downlink transmitter or receiver to the downlink antenna in time duplex fashion.

Although many OFDM/OFDMA systems will use OFDM/OFDMA technology in both directions, those skilled in the art will recognize that the present embodiments of the invention are applicable to systems using OFDM/OFDMA technology in only one direction, with an alternative transmission technology (or even radio silence) in the opposite direction. Furthermore, it should be understood by a person of ordinary skill in the art that the OFDM/OFDMA transceiver modules 202/208 may utilize other communication techniques such as, without limitation, a frequency division duplex (FDD) communication technique.

The mobile station transceiver 208 and the base station transceiver 202 are configured to communicate via a wireless data communication link 214. The mobile station transceiver 208 and the base station transceiver 202 cooperate with a suitably configured RF antenna arrangement 206/212 that can support a particular wireless communication protocol and modulation scheme. In the exemplary embodiment, the mobile station transceiver 208 and the base station transceiver 202 are configured to support industry standards such as the Third Generation Partnership Project Long Term Evolution (3GPP LTE), Third Generation Partnership Project 2 Ultra Mobile Broadband (3 Gpp2 UMB), Time Division-Synchronous Code Division Multiple Access (TD-SCDMA), and Wireless Interoperability for Microwave Access (WiMAX), and the like. The mobile station transceiver 208 and the base station transceiver 202 may be configured to support alternate, or additional, wireless data communication protocols, including future variations of IEEE 802.16, such as 802.16e, 802.16m, and so on.

According to certain embodiments, the base station 102 controls the radio resource allocations and assignments, and the mobile station 104 is configured to decode and interpret the allocation protocol. For example, such embodiments may be employed in systems where multiple mobile stations 104 share the same radio channel which is controlled by one base station 102. However, in alternative embodiments, the mobile station 104 controls allocation of radio resources for a particular link, and could implement the role of radio resource controller or allocator, as described herein.

Processor modules 216/222 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration. Processor modules 216/222 comprise processing logic that is configured to carry out the functions, techniques, and processing tasks associated with the operation of OFDM/OFDMA system 200. In particular, the processing logic is configured to support the OFDM/OFDMA frame structure parameters described herein. In practical embodiments the processing logic may be resident in the base station and/or may be part of a network architecture that communicates with the base station transceiver 202.

The steps of a method or algorithm described in connection with the embodiments disclosed herein may be embodied directly in hardware, in firmware, in a software module executed by processor modules 216/222, or in any practical combination thereof. A software module may reside in memory modules 218/220, which may be realized as RAM memory, flash memory, ROM memory, EPROM memory, EEPROM memory, registers, a hard disk, a removable disk, a CD-ROM, or any other form of storage medium known in the art. In this regard, memory modules 218/220 may be coupled to the processor modules 218/222 respectively such that the processors modules 216/220 can read information from, and write information to, memory modules 618/620. As an example, processor module 216, and memory modules 218, processor module 222, and memory module 220 may reside in their respective ASICs. The memory modules 218/220 may also be integrated into the processor modules 216/220. In an embodiment, the memory module 218/220 may include a cache memory for storing temporary variables or other intermediate information during execution of instructions to be executed by processor modules 216/222. Memory modules 218/220 may also include non-volatile memory for storing instructions to be executed by the processor modules 216/220.

Memory modules 218/220 may include a frame structure database (not shown) in accordance with an exemplary embodiment of the invention. Frame structure parameter databases may be configured to store, maintain, and provide data as needed to support the functionality of system 200 in the manner described below. Moreover, a frame structure database may be a local database coupled to the processors 216/222, or may be a remote database, for example, a central network database, and the like. A frame structure database may be configured to maintain, without limitation, frame structure parameters as explained below. In this manner, a frame structure database may include a lookup table for purposes of storing frame structure parameters.

The network communication module 226 generally represents the hardware, software, firmware, processing logic, and/or other components of system 200 that enable bi-directional communication between base station transceiver 202, and network components to which the base station transceiver 202 is connected. For example, network communication module 226 may be configured to support internet or WiMAX traffic. In a typical deployment, without limitation, network communication module 226 provides an 802.3 Ethernet interface such that base station transceiver 202 can communicate with a conventional Ethernet based computer network. In this manner, the network communication module 226 may include a physical interface for connection to the computer network (e.g., Mobile Switching Center (MSC)).

In accordance with embodiments described herein, time-frequency allocation units are referred to as Resource Blocks (RBs). A Resource Block (RB) is defined as a fixed-size rectangular area within a subframe comprised of a specified number of subcarriers (frequencies) and a specified number of OFDMA symbols (time slots). An RB is the smallest fundamental time-frequency unit that may be allocated to an 802.16m or LTE user.

The power control techniques according to various embodiments will be described in terms of a downlink signal model. One of ordinary skill in the art would understand that the uplink signal model would operate in a similar manner. The following notation is used in the description:
N_{T} denotes the number of BS 102 transmit antennas 206.
N_{R} denotes the number of MS 104 receive antennas 212.
N_{S}<=min(N_{T}, N_{R}) denotes the number of independent spatial streams transmitted by the BS.
WεC^{N}_{T}*^{N}_{S} denotes the linear precoding matrix for the BS.
PεR^{N}_{S}*^{N}_{S} denotes the diagonal stream power loading matrix for the BS with diagonal elements: P_{T,,i}, i=1, 2, . . . , N_{S}.
sεC^{N}_{S}^{x1} denotes the data symbol vector transmitted by the BS.
HεC^{N}_{R}*^{N}_{T} denotes the MS's 104 channel matrix. The (i, j)th element of H represents the channel gain and phase associated with the signal path from MS 104 transmit antenna j to BS 102 receive antenna i. The channel matrices are assumed fixed during the transmission duration but may change independently from one subframe to the next.

The downlink signal transmitted by the BS 102 may be written as

x=WPsεC^{N}_{T}^{x1} (1)

According to certain embodiments, it can be assumed that the data symbol vector s has normalized unit energy and the following mean and covariance:

E[s]=0 (2)

Rₛ=E[ss^{H}]=I_{NT} (3)

where I_{NT}εR^{NT*NT} denotes an identity matrix. The total average transmit power distributed over N_{T} antennas is

P_{T}=Tr{WPP^{H}W^{H}} (4)

where Tr denotes the trace of the matrix.

According to an exemplary embodiment, it can be assumed that the cyclic prefix is greater in length than the channel delay spread and that the maximum Doppler frequency is much smaller than the OFDM symbol subcarrier spacing. According to an embodiment, one can therefore ignore any inter-subcarrier interference caused by Doppler frequency spreading. Under these assumptions, the received MS 104 signal may be written as

y=Hx+nεC^{N}_{R}^{x1} (5)

where nεC^{N}_{R}^{x1} denotes an interference-plus-noise vector with the following mean and covariance:

E[n]=0 (6)

Rₙ=E[nn^{H}]εC^{N}_{R}^{xN}_{R} (7)

To see the impact of power changes on the received signal one can set N_{S}=2, N_{T}=2, and N_{R}=2. The above received signal can then be written as:

$$\begin{matrix} ( \begin{matrix}y 1 \\ y 2\end{matrix} ) = ( \begin{matrix}{h}_{11} {h}_{12} \\ {h}_{21} {h}_{22}\end{matrix} ) ( \begin{matrix}{w}_{11} {w}_{12} \\ {w}_{21} {w}_{22}\end{matrix} ) ( \begin{matrix}{P}_{Tx , 1} & 0 \\ 0 & {P}_{Tx , 2}\end{matrix} ) ( \begin{matrix}{s}_{1} \\ {s}_{2}\end{matrix} ) + ( \begin{matrix}{n}_{1} \\ {n}_{2}\end{matrix} ) & ( 8 ) \\ = ( \begin{matrix}{h}_{11} ( {w}_{11} {P}_{Tx , 1} {s}_{1} + {w}_{12} {P}_{Tx , 2} {s}_{2} ) + {h}_{12} ( {w}_{21} {P}_{Tx , 1} {s}_{1} + {w}_{22} {P}_{Tx , 2} {s}_{2} ) \\ {h}_{21} ( {w}_{11} {P}_{Tx , 1} {s}_{1} + {w}_{12} {P}_{Tx , 2} {s}_{2} ) + {h}_{22} ( {w}_{21} {P}_{Tx , 1} {s}_{1} + {w}_{22} {P}_{Tx , 2} {s}_{2} )\end{matrix} ) + ( \begin{matrix}{n}_{1} \\ {n}_{2}\end{matrix} ) & ( 9 )\end{matrix}$$

where P_{T}=P_{Tx,1}+P_{Tx,2}. It can be seen that an increase/decrease in P_{Tx,1} or P_{Tx,2} can be observed in all MS 104 receive antennas 212. The post-processing SINRs of the spatial streams are dependent on the particular MIMO receive signal processing implemented at the MS. Post-processing SINRs may be independent or coupled via “crosstalk” among the spatial streams. For a zero-forcing (ZF) receiver the detected spatial streams are decoupled by the receiver signal processing so changing the transmit power of one spatial stream does not affect the post-processing SINRs of the other spatial streams. In contrast, for the MMSE or Wiener filter MIMO receiver, the post-processing SINR of each spatial stream is coupled to the other spatial streams. Hence for this case an increase or decrease in transmit power of one spatial stream will affect the post-processing SINRs of the other spatial streams. More specifically, the post-processing SINRs of the ith spatial stream for a zero-forcing receiver and a Wiener filter receiver may be written as:

$$\begin{matrix}{SINR}_{i}^{ZF} = \frac{1}{{{σ}_{n}^{2} [ {( {H}^{H} H )}^{- 1} ]}_{ii}} \\ and & ( 10 ) \\ {SINR}_{i}^{WF} = {b}_{i}^{H} {H}^{H} {R}_{ni}^{- 1} Hbi & ( 11 )\end{matrix}$$

where [(H^{H}H)⁻¹]ᵢᵢ denotes the ith diagonal element of (H^{H}H)^{-1,} bᵢ denotes the ith column of the matrix product Bₖ=WP, and

Rₙᵢ=E[nᵢnᵢ^{H}]=Rₙ+H(BₖBₖ^{H}−bᵢbᵢ^{H})H^{H}εC^{N}_{R}^{xN}_{R} (12)

The covariance matrix of n, which denotes the interference-plus-noise associated with the ith spatial stream. From the above equations it can be seen that the SINRᵢ^{ZF} values are independent. In contrast, SINR_{k,i}^{WF} values are correlated or coupled due to matrix Bₖ within the equation for Rₙᵢ.

One approach to simplify and decouple the space-time power control technique is to uniformly distribute power over all transmit antennas and to equally allocate power increments/decrements to all transmit antennas. Let P_{T}/N_{T} denote the average per-antenna power. It can then be seen that:

$$\begin{matrix}{b}_{i} = ( {P}_{T} / {N}_{T} ) {w}_{i} & ( 13 ) \\ {B}_{k} {B}_{k}^{H} = {( {P}_{T} / {N}_{T} )}^{2} {WW}^{H} \\ and & ( 14 ) \\ {R}_{ni} = {R}_{n} + {( {P}_{T} / {N}_{T} )}^{2} H ( {WW}^{H} - {w}_{i} {w}_{i}^{H} ) {H}^{H} & ( 15 )\end{matrix}$$

The total average transmit power P_{T} for all N_{T} transmit antennas may be allocated to the data streams using P_{T}/N_{T} so the total transmit power is uniformly distributed. This is true even if only some subset of the antennas is used for data transmission. In this case N_{S}<N_{T} so the total power used is less than P_{T}.

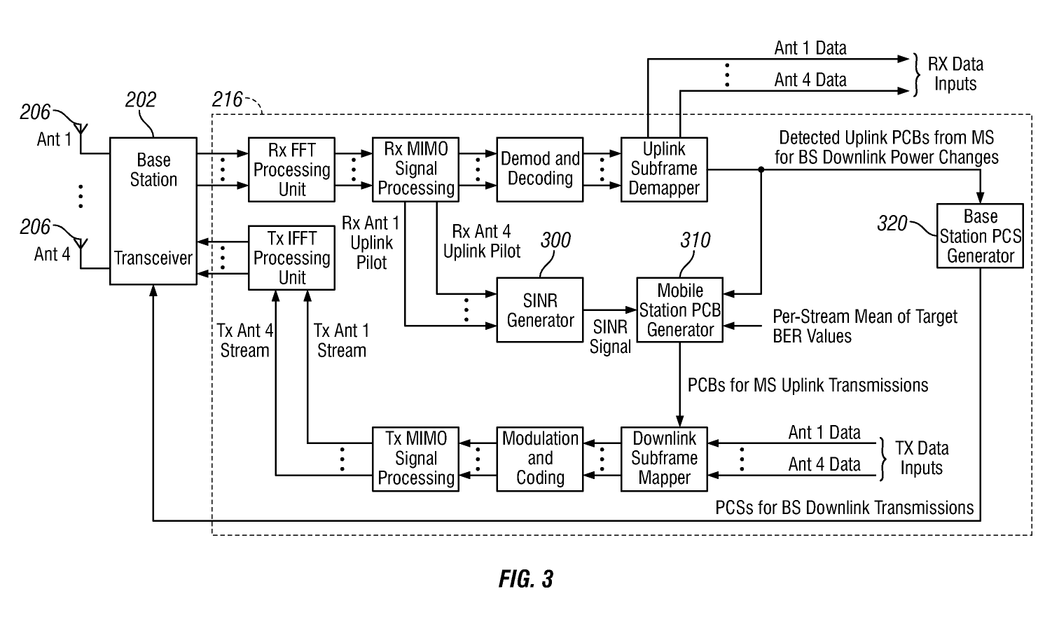

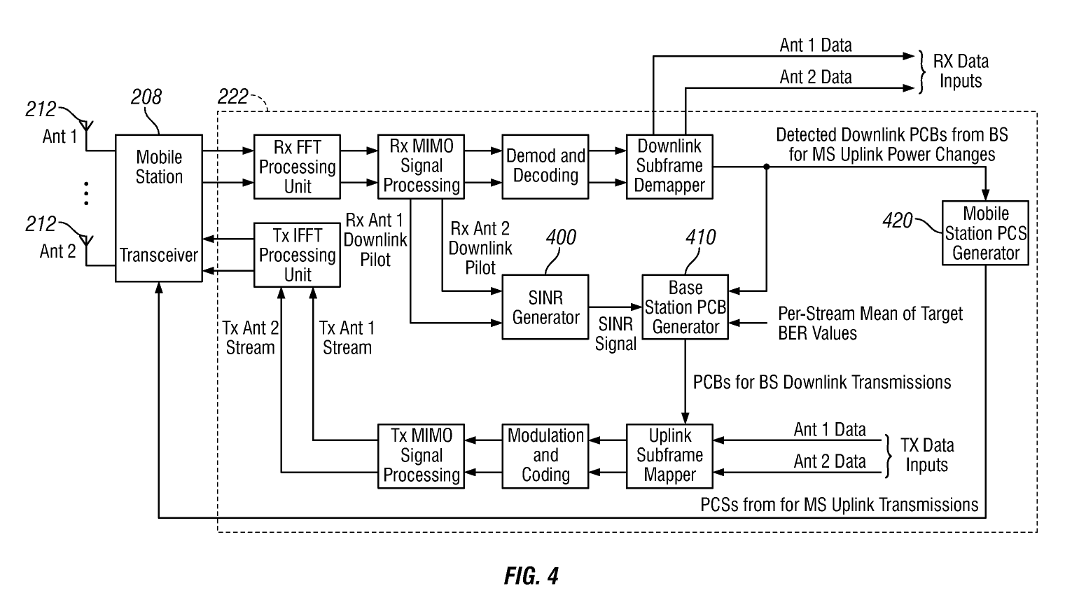

FIGS. 3 and 4 show detailed exemplary BS 102 and MS 104 block diagrams, respectively, for closed-loop power control techniques, according to certain embodiments. Exemplary control techniques are described below in terms of MS 104 operations. However, one of ordinary skill in the art would realize that the BS 102 can function in a similar manner, and thus a description of its operation is not provided.

The exemplary BS 102 of FIG. 3 includes four antennas 206 and the exemplary MS 104 includes two antennas 212. However, these antennas are illustrated for exemplary purposes only, and various numbers of antenna 206 and 212 can be implemented in the MIMO system.

According to certain aspects, the BS 102 can first specify a power increment or decrement for an MS's 104 uplink transmissions using a single power control bit (PCB). Each BS-specified power control bit indicates a power increment or decrement for an MS's 104 transceiver module 208 (also referred to as the MS's 104 transmitter 208, according to the exemplary embodiment). According to an embodiment, a power control bit equal to a logical 0 commands an MS 104 power increase; a power control bit equal to a logical 1 commands an MS 104 power decrease. The BS 102 periodically transmits PCBs to an MS 104 in a downlink subframe control field. The control field may support a single PCB or multiply copies of the PCB if repetition coding is used for increased reliability. Hence the rate at which MS 104 power control adjustments can occur can be based on the transmit rate of the downlink control field. At the receive side, a recipient MS 104 detects the BS-transmitted PCB. The detected PCB is then used to derive a Power Control Step (PCS) for the MS's 104 transceiver module 208. The MS 104 adjusts its transmitter's 208 power amplifier in accordance with the derived PCS.

Typical signal quality estimates used for closed-loop power control, signal power estimates and/or estimates of the ratio of received signal power to interference-plus-noise power (SINR) may be received. It can be seen that SINR-based power control methods have better performance than signal power estimates only. An important advantage of an SINR-based power control method is that average transmit power can be reduced as network load decreases, thereby reducing network interference and conserving power.

When using SINR-based closed-loop power control is that a positive feedback situation may arise. To clarify the problem, consider a number of MSs 104 communicating within the boundaries of cell edges. Suppose one of the MSs 104 detects a BS-transmitted PCB that specifies a power increase in order to meet a required QoS level. Based on the detected PCB the MS 104 increases it transmit power which may result in increased interference to the other nearby MSs 104 in the network. Hence, in response, the other MSs 104 increase their transmit power which further increases network interference. The process continues until all MSs 104 are at their maximum allowed transmit power. If better estimates of SINR are obtained this problem can be mitigated.

More accurate SINR values may be computed using a pilot signal as a reference rather than a detected data signal. This is due to the fact that a pilot signal has a constant or slowly varying power level in contrast to a data signal that typically varies more in power in order to accommodate data rate changes. Data signals are also more difficult to track for power control purposes.

In a MIMO system with N_{T} transmit and N_{R} receive antennas the number of independent and resolvable spatial streams is N_{S}<=min(N_{T}, N_{R}) if the MIMO channel matrix is of full-rank. Each spatial stream is associated with a post-processing SINR which is the measured after MIMO receiver signal processing.

The example MS SINR Generator 400 of FIG. 4 can use two dedicated downlink pilots as reference signals for post-processing SINR predictions; however, other numbers may be implemented without departing from the scope of the present disclosure. Given received versions of the reference pilots as inputs, the SINR Generator 400 first computes estimates of the post-processing SINR for each spatial stream. Given these SINR estimates, the SINR Generator 400 can then combines the SINR estimates into a single estimate by computing their average, for example (other statistics may also be used without departing from the scope of the disclosure). The SINR Generator 400 then computes a predicted SINR value SINR_{BS}[n] using the single SINR estimate just computed and past SINR estimates computed in the same manner. For example, a simple least mean square (LMS) or Kalman algorithm may used for an SINR predictor to output SINR_{BS}[n]. Note that the SINR prediction step is optional but performance comparisons indicate that predictive power control typically performs better.

The post-processing SINR Predictor values SINR_{BS}[n] are then input to the Base Station PCB Generator 410. The Base Station PCB Generator 410 outputs a binary signal comprised of, for example, power control bit samples PCB_{BS}[n]. The PCB samples specify power increments or decrements for BS-to-MS downlink transmissions. The PCB samples can be transmitted to the BS 102; the PCB samples can then be used by the BS 102 to adjust its power for downlink transmissions to the MS 104.

To generate PCB samples the Base Station PCB Generator 410 compares samples SINR_{BS}[n] output from the SINR Generator 400 with target SINR samples SINR_{BS}[n]. A target SINR sample SINR_{BS}[n] is the post-processing SINR utilized to achieve the target bit error rate (BER) for a particular data rate or quality of service (QoS).

To generate a target SINR sample SINR_{BS}[n] the Base Station PCB Generator 410 first generates a BER signal with samples BER_{BS}[n]. For example, an estimate of the BER as a function of SINR_{BS}[n] and an M-QAM modulation parameter M is as follows:

$${\hat{BER}}_{BS} [ n ] = \frac{4}{{log}_{2} M} [ 1 - \frac{2}{\sqrt{M}} ] Q [ \sqrt{\frac{3}{M - 1} {\hat{SINR}}_{BS} [ n ]} ] \qquad ( 16 )$$

Samples BER_{BS}[n] of the estimated bit error rate signal produced by the Base Station PCB Generator 410 are then used to generate a downlink SINR setpoint sample SINR_{BS}[n]. A target or reference BER value from a set of target BER values BER¹_{BS}, i=1, 2, . . . , P, can also be used for this purpose. Note that the target BER values may be per-stream mean BERs if a multi-codeword or horizontal MIMO technique is the mode of operation being used. Given a sample BER_{BS}[n] and a target BER value BERⁱ_{BS} the Base Station PCB Generator 410 outputs an SINR setpoint sample SINR_{BS}[n] using a map such as the following:

$${SINR}_{BS} [ n ] = \{ \begin{matrix}{SINR}_{Up}^{SP} & if < {BER}_{BS}^{i} \leq {\hat{BER}}_{BS} [ n ] \\ {SINT}_{Down}^{SP} & if < {\hat{BER}}_{BS} [ n ] < {BER}_{BS}^{i}\end{matrix} \qquad ( 17 )$$

Samples SINR_{BS}[n] are SINR values used to meet a specified target BER. Samples BERⁱ_{BS}, i=1, 2, . . . , P, of the QoS Reference Signal may be bit error rate values set in accordance with a downlink quality of service. For example, if BER_{BS}[n] is too low for a specified downlink channel QoS indexed by BER¹_{BS} then SINR_{BS}[n] would be set to SINR^{SP}_{UP} specifying that a higher SINR is required. Alternatively, if BER_{BS}[n] is more than the target BER BERⁱ_{BS}, the setpoint sample SINR_{BS}[n] would be set to SINR^{SP}_{Down} specifying that a lower SINR is required. The chosen value SINR^{SP}_{Down} may be a decrement so that the power is minimized and interference is decreased.

Given input SINR_{BS}[n] (samples) and SINR_{BS}[n] the Base Station PCB Generator 410 then outputs a base station PCB sample PCB_{BS}[n] using the map:

$${PCB}_{BS} [ n ] = \{ \begin{matrix}1 & ( B S power decrease ) & if {SINR}_{BS} [ n ] < {\hat{SINR}}_{BS} [ n ] \\ 0 & ( B S power decrease ) & if {SINR}_{BS} [ n ] \geq {\hat{SINR}}_{BS} [ n ]\end{matrix} \qquad ( 18 )$$

Samples PCB_{BS}[n] form a BS 102 power control signal that is used by the BS 102 to adjust its downlink power when communicating with the MS 104. If PCB_{BS}[n]=0 a BS 102 power increase is specified by the MS 104; if PCB_{BS}[n]=1 a BS 102 power decrease is specified by the MS 104. The resulting PCB sample PCB_{BS}[n] is mapped onto the MS's 104 uplink subframe and subsequently transmitted back to the BS 102 where it is detected.

At the BA 102, PCB samples for the MS 104 are computed using the map:

$${PCB}_{MS} [ n ] = \{ \begin{matrix}1 & ( M S power decrease ) & if {SINR}_{MS} [ n ] < {\hat{SINR}}_{MS} [ n ] \\ 0 & ( M S power decrease ) & if {SINR}_{MS} [ n ] \geq {\hat{SINR}}_{MS} [ n ]\end{matrix} \qquad ( 19 )$$

where SINR_{MS}[n] and SINR_{MS}[n] (samples) denote SINR setpoint and predicted mobile station received SINR values. At the BS 102, values PCB_{MS}[n], SINR_{MS}[n] and SINR_{MS}[n] are generated using the same processing as described above for the MS 104. See FIG. 3 for clarification, where SINR Generator 300, MS PCB Generator 310 and BS PCS Generator 320 can function in a substantially similar manner as SINR Generator 400, BS PCB Generator 410 and MS PCS Generator 420 described above with respect to FIG. 4.

Waveform quantization is a signal compression technique in which samples of a signal are mapped to discrete steps or levels; each step is represented by a minimal number of bits for compression purposes. Differential or predictive quantization is a waveform quantization method in which the difference between a sample and a predicted sample is quantized rather than the sample. Continuously Variable Slope Delta Modulation (CVSD) is a differential waveform quantization method with adaptive step-size adjustment. By adapting the step-size to changes in slope of a differenced signal, CVSD is better able to quantize differenced signals. When the slope of a signal changes too quickly for CVSD to track, step-size is increased. Conversely, when the slope changers too slowly, step-size is decreased. In this manner slope overload and granular errors may be reduced.

At the MS 104, power control bit samples PCB_{MS}[n] are detected from BS-to-MS downlink transmissions. Given detected power control bits samples PCB_{BS}[n] the MS's 104 Power Control Step Size Generator 420 can implement PCS size adaptation using a CVSD circuit such as that shown in FIG. 6. As shown in FIG. 6, the CVSD circuit is comprised of a slope-overload detector and an integrator. The adaptation mechanism implemented by the Power Control Step Size Generator 420 is based on PCB patterns detected during segments of slope-overload. From the map above for samples PCB_{MS}[n] it is clear that in the absence of channel errors, segments of slope-overload error will be manifested by runs of consecutive PCB_{MS}[n] values of logic zero or one. For example, a PCB run pattern associated with slope overload may be bit sequence of 0,0,0,0 or 1,1,1,1. These patterns are used by the Power Control Step Size Generator 420 for PCS size adaptation.

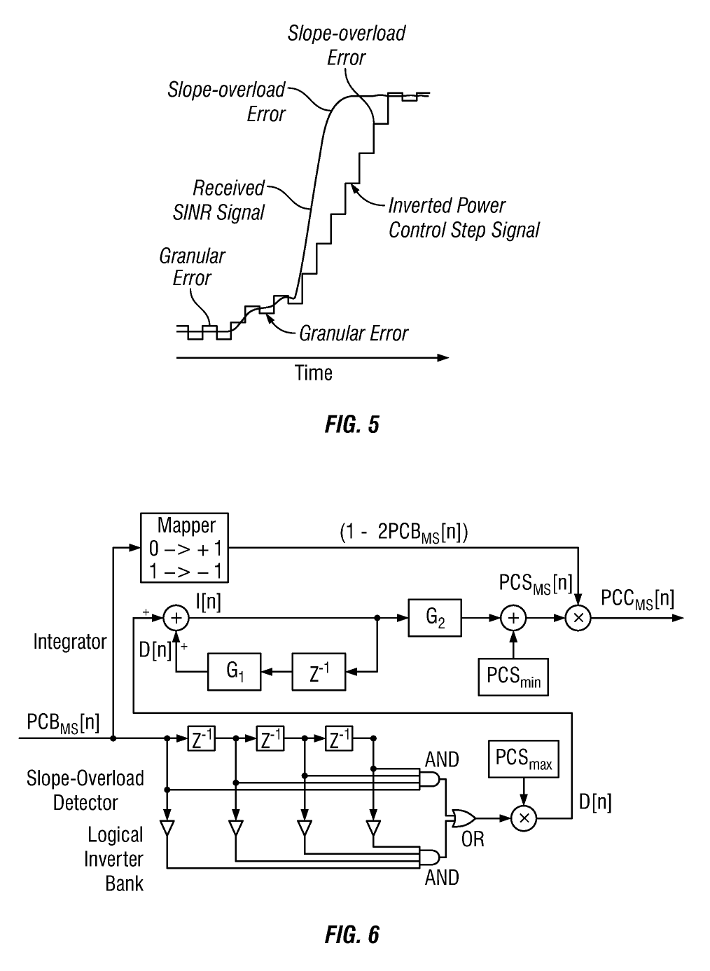

FIG. 5 is an illustration of slope overload and granular errors. An inverted PCS signal should ideally match received SINR signal. Slope-overload error results if the PCS size is too small to inversely track segments of received SINR that have fast or abruptly changing slopes. If the PCS size is too large in segments of received SINR that have small or zero slopes a type of error called granular error will arise.

Referring back to FIG. 6, The Slope-overload Detector of the Power Control Step Size Generator 420 first computes:

$$D [ n ] = \{ \begin{matrix}P C {S}_{max} & if \{ P C {B}_{MS} [ j ] , j = n - 3 , … , n \} = \{ 0 , 0 , 0 , 0 \} \\ P C {S}_{max} & if \{ P C {B}_{MS} [ j ] , j = n - 3 , … , n \} = \{ 1 , 1 , 1 , 1 \} \\ 0 & otherwise \end{matrix} \qquad ( 20 )$$

where positive real-values PCSmax is the maximum allowed power control step size allowed.

Given D[n] the Integrator of the Power Control Step Size Generator 420 then computes:

I[n]=G₁I[m−1]+D[n] (21)

followed by the MS's 104 power control step sample:

PCS_{MS}[n]=G₂I[n]+PCSₘᵢₙ (22)

where positive real-value PCSmin is the minimum allowed power control step size allowed. Samples PCS_{MS}[n] are constrained to lie within the interval [PCSmin,PCSmax]. Appropriate values for parameters G₁, G₂, PCSmin and PCSmax can be determined by determined by computer simulations or set in accordance with the standard. For example, PCSmin and PCSmax values of 0 and 2.0, respectively, may be used.

It should be understood that PCS_{MS}[n] is computed using a set of received PCB samples to adjust the MS's 104 transmitter power rather than a single PCB value. Thus the Power Control Step Size Generator 420 can incorporate the memory or autocorrelation statistic of the received PCB time series {PCB_{MS}[j], j=n−3, . . . , n}into its operation. This approach provides better power control step sizes for the MS's 104 transmitter and thereby allows better channel tracking for the power control loop. Also, the set of received PCB samples used can be changed in length. For example, an alternative set is {PCB_{MS}[j], j=n−5, . . . , n} with six PCS_{MS}[n] values.

Given the received PCB_{MS}[n] bit from the BS 102 and the power control step PCS_{MS}[n] the Power Control Step Size Generator 420 next updates the MS's 104 power control step sample as:

PCS_{MS}[n]=(1−2PCB_{MS}[n])PCS_{MS}[n] (23)

Note that PCS_{MS}[n] is computed by multiplying PCS_{MS}[n] with a detected binary-to-bipolar mapped value (1−2PCB_{MS}[n]). Recall that if PCB_{MS}[n]=0 an MS 104 power increase is specified by the BS 102 and if PCB_{MS}[n]=1 an MS 104 power decrease is specified by the BS 102. Hence, the update specifies the direction of the power control step PCB_{MS}[n].

Note that the power control step PCB_{MS}[n] is increased to reduce slope-overload errors and decreased to reduce granular errors. Also, PCS increments and decrements for the MS's 104 transmitter need not be assigned by the BS 102 via downlink signaling. The MS 104 can generate optimal PCSs in an autonomous manner thereby reducing signaling overhead and associated delays which would occur if the BS 102 transmitted PCS values for the MS 104 to use.

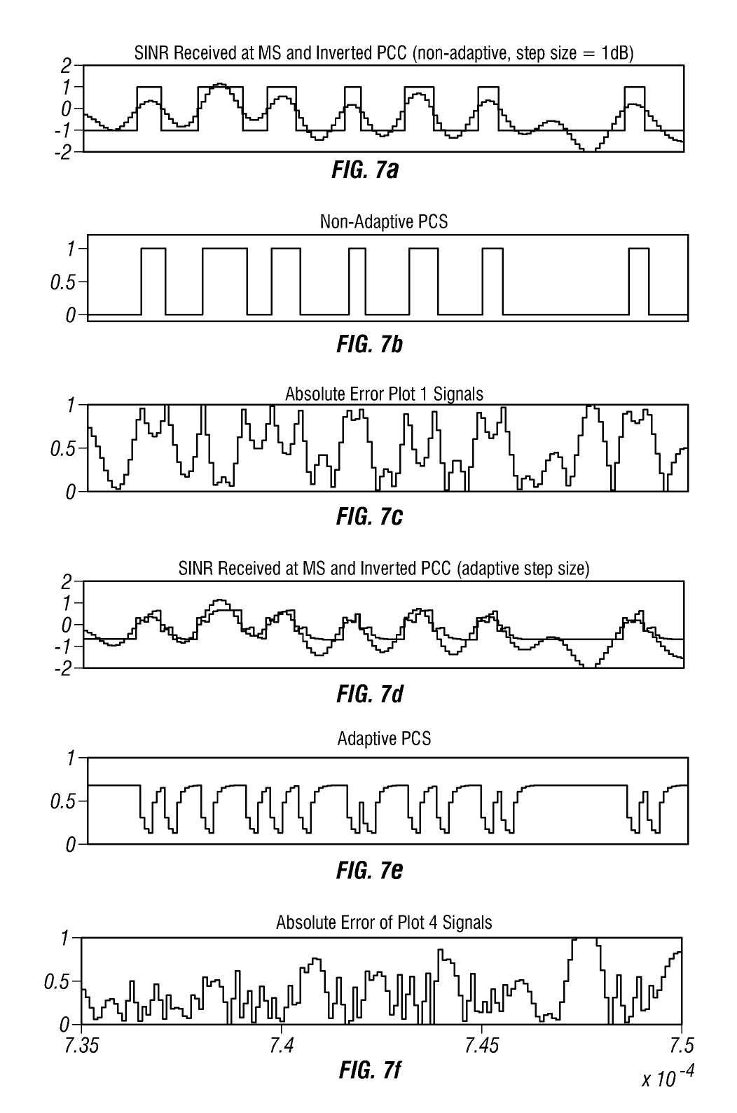

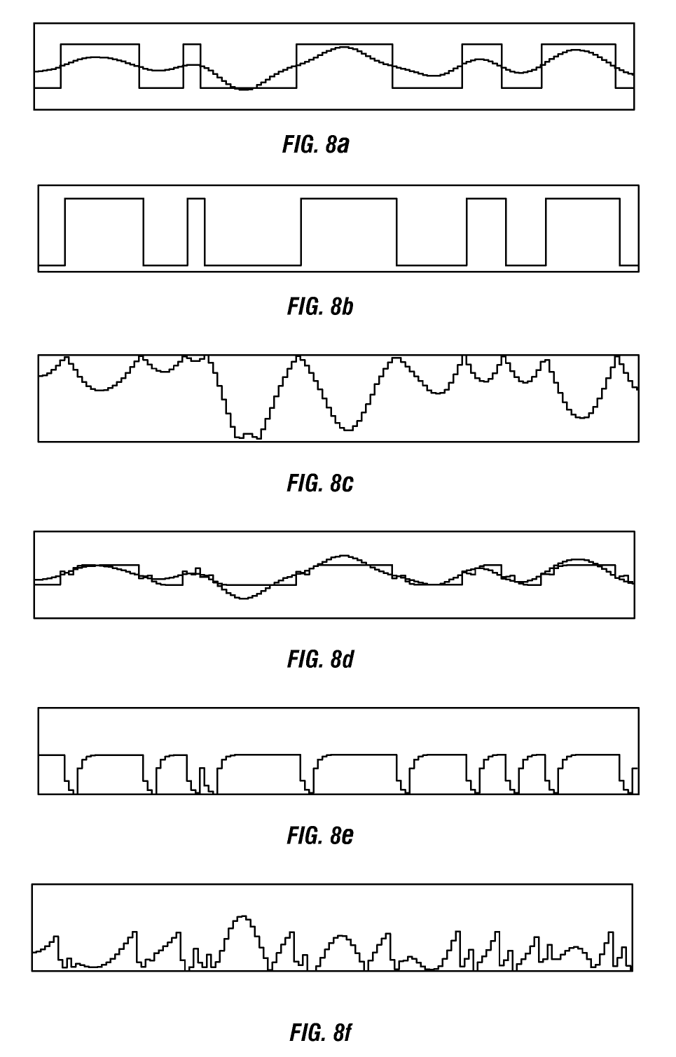

FIGS. 7 and 8 show example plots output by the Power Control Step Size Generator 420, for example. The parameters used are as follows: PCSmax=2, PCSmin=0, G₁=0.35, and G₂=0.15. For comparison, the first three plots (FIGS. 7(a)-7(c) and FIGS. 8(a)-8(c)) show the results for a fixed PCS of 1 dB. The second group of three plots (FIGS. 7(d)-7(f) and FIGS. 8(d)-8(f)) shows the improvement using the Power Control Step Size Generator 420 described above.

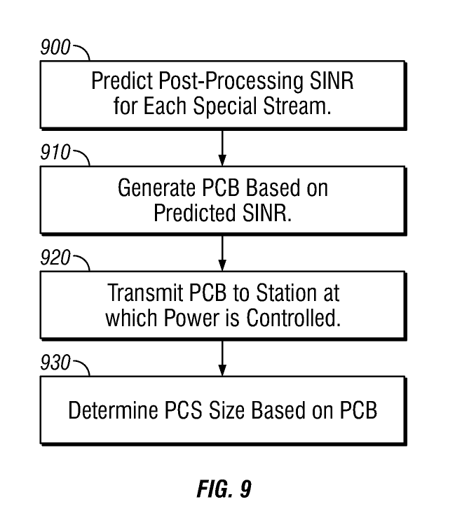

FIG. 9 is a flowchart illustrating a method for controlling transmit power at a station in a multiple in, multiple out (MIMO) system. Referring to FIG. 9, at operation 900, SINR Generator 400 (or 300) is configured to predict a post-processing signal to interference-plus-noise ratio (SINR), based on at least one previous and current SINR estimate, for each spatial stream. According to an embodiment described herein, the predicted SINRs for each spatial stream can be combined into a single estimate by averaging the predicted SINRs. A predicted SINR value can be computed using the combined single estimate and one or more past SINR estimates.

Thereafter, the process continues to operation 910, where at least one power control bit (PCB) is generated by BS or MS PCB Generator 410 or 310, based on the predicted SINR. The PCB generator 410 or 310 can compare the predicted SINR value with one or more target SINR samples, wherein the one or more target SINR samples are based on a target bit error rate signal for a particular data rate or quality of service (QoS), for example.

From operation 910, the process continues to operation 920, where transceiver module 208 or 202 transmits the at least one PCB to the station at which transmit power is controlled. From operation 910, the process continues to operation 930 where a power control step (PCS) size is determined by PCS Generator 420 or 320, based on the PCB.

Implementing the usage of SINR prediction and adaptive PCS size prediction within a closed loop power control implementation, as described herein, helps lessen the incorrect setting of PCBs. Using the proposed techniques, PCS sizes for a transmitter of either an MS 104 or a BS 102 may be adaptively predicted using previous and present detected PCBs. Slope overload and granular error arise due to non-optimal PCS sizes; however, adaptive PCS sizes help mitigate such unwanted effects. As another advantage in using received PCBs for adaptively predicting PCSs, 1-bit power command signals may be used for multiple step-size power control.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the invention.

In this document, the terms “computer program product”, “computer-readable medium”, and the like, may be used generally to refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), when executed, enable the computing system.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization.

Furthermore, although individually listed, a plurality of means, elements or method steps may be implemented by, for example, a single unit or processing logic element. Additionally, although individual features may be included in different claims, these may possibly be advantageously combined. The inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for controlling transmit power at a station in a multiple in, multiple out (MIMO) system, comprising:
predicting a post-processing signal to interference-plus-noise ratio (SINR), based on at least one previous and current SINR estimate, for each spatial stream;
generating at least one power control bit (PCB) based on the predicted SINR; and
transmitting the at least one PCB to the station at which transmit power is controlled.

2. The method of claim 1, the predicting comprising:
combining the predicted SINRs for each spatial stream into a single estimate by averaging the predicted SINRs.

3. The method of claim 2, the predicting further comprising:
computing a predicted SINR value using the combined single estimate and one or more past SINR estimates.

4. The method of claim 1, the generating a PCB further comprising:
comparing the predicted SINR value with one or more target SINR samples, wherein the one or more target SINR samples are based on a target bit error rate signal for a particular data rate or quality of service.

5. The method of claim 1, further comprising:
determining a power control step (PCS) size based on the PCB at the station at which transmit power is controlled.

6. The method of claim 1, wherein the station is a base station.

7. The method of claim 1, wherein the station is a mobile station.

8. A system for controlling transmit power at a station in a multiple in, multiple out (MIMO) system, comprising:
a signal to interference-plus-noise ratio (SINR) generator configured to predict a post-processing SINR, based on at least one previous and current SINR estimate, for each spatial stream;
a power control bit (PCB) generator configured to generate at least one PCB based on the predicted SINR; and
a transceiver module configured to transmit the at least one PCB to the station at which transmit power is controlled.

9. The system of claim 8, the SINR generator further configured to:
combine the predicted SINRs for each spatial stream into a single estimate by averaging the predicted SINRs.

10. The system of claim 9, the SINR generator further configured to:
compute a predicted SINR value using the combined single estimate and one or more past SINR estimates.

11. The system of claim 8, the PCB generator further configured to:
compare the predicted SINR value with one or more target SINR samples, wherein the one or more target SINR samples are based on a target bit error rate signal for a particular data rate or quality of service.

12. The system of claim 8, further comprising:
a power control step (PCS) generator configured to determine a power control step (PCS) size based on the PCB at the station at which transmit power is controlled.

13. The system of claim 8, wherein the station is a base station.

14. The system of claim 8, wherein the station is a mobile station.

15. A computer-readable medium storing instructions thereon for performing a method of controlling transmit power at a station in a multiple in, multiple out (MIMO) system, the method comprising:
predicting a post-processing signal to interference-plus-noise ratio (SINR), based on at least one previous and current SINR estimate, for each spatial stream;
generating at least one power control bit (PCB) based on the predicted SINR; and
transmitting the at least one PCS to the station at which transmit power is controlled.

16. The computer-readable medium of claim 15, the predicting comprising:
combining the predicted SINRs for each spatial stream into a single estimate by averaging the predicted SINRs.

17. The computer-readable medium of claim 16, the predicting further comprising:
computing a predicted SINR value using the combined single estimate and one or more past SINR estimates.

18. The computer-readable medium of claim 15, the generating a PCB further comprising:
comparing the predicted SINR value with one or more target SINR samples, wherein the one or more target SINR samples are based on a target bit error rate signal for a particular data rate or quality of service.

19. The computer-readable medium of claim 15, the method further comprising:
determining a power control step (PCS) size based on the PCB at the station at which transmit power is controlled.

20. The computer-readable medium of claim 15, wherein the station is a base station.

21. The computer-readable medium of claim 15, wherein the station is a mobile station.

22. A system, comprising:
means for predicting a post-processing signal to interference-plus-noise ratio (SINR), based on at least one previous and current SINR estimate, for each spatial stream of a multiple in, multiple out (MIMO) system;
means for generating at least one power control bit (PCB) based on the predicted SINR;
means for transmitting the at least one PCB to a station at which transmit power is controlled; and
means for determining a power control step (PCS) size based on the PCB.
